(19) United States
(12) Patent Application Publication
(10) Pub. No.: US 2014/0280125 A1
(43) Pub. Date: Sep. 18, 2014

(54) METHOD AND SYSTEM TO BUILD A TIME-SENSITIVE PROFILE

(71) Applicants: Anurag Bhardwaj, Sunnyvale, CA (US); Robinson Piramuthu, Oakland, CA (US); Neelakantan Sundaresan, Mountain View, CA (US)

(72) Inventors: Anurag Bhardwaj, Sunnyvale, CA (US); Robinson Piramuthu, Oakland, CA (US); Neelakantan Sundaresan, Mountain View, CA (US)

(73) Assignee: eBay Inc., San Jose, CA (US)

(21) Appl. No.: 13/804,664

(22) Filed: Mar. 14, 2013

(51) Int. Cl. G06F 17/30

(52) U.S. Cl. CPC G06F 17/30345
USPC 707/736

(57) ABSTRACT

A system to build a time-sensitive profile is described. A plurality of sensing devices collect respective different types of information. A data collector receives sensor data collected by an electronic sensing device. A historical profile detector determines a historical profile associated with the first sensor data and that the historical profile is to be updated using the first sensor data. A profile generator then updates the historical profile using the sensor data.

### TECHNICAL FIELD

This application relates to the technical fields of software and/or hardware technology and, in one example embodiment, to system and method to build a time-sensitive profile.

### BACKGROUND

Some existing consumer electronics products can be worn by a user and can be designed to collect data associated with the wearer's activities. A device may be configured to collect physiological and movement data of a user. For example, highly accurate, low cost Micro-Electro-Mechanical Systems (MEMS) motion sensor devices, such as accelerometers, have already found their way into wearable sensors to perform basic tasks such as step counting and to monitor overall activity levels.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which example method and system to build a time-sensitive profile may be implemented;

FIG. 2 is schematic diagram of a profile of a user, in accordance with one example embodiment;

FIG. 3 is schematic diagram illustrating historical profiles of a user, in accordance with one example embodiment;

FIG. 4 is block diagram of a system to interact with devices within an intra-body area network, in accordance with one example embodiment;

FIG. 5 is a flow chart of a method to build a time-sensitive profile, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

Method and system to build a time sensitive profile are described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

As mentioned above, an electronic device may be designed to be worn by a user and can also be able to collect data associated with the wearer's activities. Wearable electronic sensing devices may be distributed over a person's body, as these devices may be embedded in various wearable items, such as glasses, earrings, shoes, shirts, etc. The data collected by various electronic sensing devices distributed over a user's body, may be analyzed, aggregated, or otherwise processed at a processing computing device, such as, e.g., a server computer system. Based on the analyzed and processed data, the server system may generate and send an electronic communication to the user. A processing computing device may also be a smart phone of a user. The electronic sensing devices positioned over a person's body may be designed to communicate with each other and with the smart phone of the user utilizing Near Field Communication (NFC) or short-wavelength radio transmissions. The collection of electronic sensing devices positioned over a person's body, together with a smart phone of the same user that is often located in close proximity to the user's body, may be termed an intra-body area network (IBAN), as these devices are located in close proximity to each other and can communicate via NFC or short-wavelength radio transmissions, such as Bluetooth®. Bluetooth® is a registered trademark of Bluetooth SIG, Inc.

As mentioned above, the data collected by electronic sensing devices within an IBAN of a user can be provided to or obtained by a processing computing device, such as a server computer system or a smart phone of the user. The collected data may be used at a processing computing device, either by itself or in combination with other data, to generate and send an electronic communication to the user. Such electronic communication may be a message, an image, an alert or some other communication. For example, if combined data from the sensors within the IBAN of a user indicates that the user may be intoxicated, a communication from the processing computing device may be a suggestion that the user should call a taxi.

In another example, an electronic sensing device may be embedded into or attached to a jacket of the user and be configured to detect any size adjustments the user performs on the jacket. Based on the size adjustment information a jacket size for the user may be determined and stored. In another example, an electronic sensing device may be embedded in a running shoe to detect that the integrity of the sole is below acceptable level, which may trigger the IBAN system to suggest that the user replaces her running shoes. Still further types of electronic sensing devices may be capable of detecting and reporting smells, changes in the movement patterns of the user, changes in the speech patterns of the user, etc.

An electronic communication generated based on the data collected by electronic sensing devices within an IBAN may also utilize a profile of the user. A profile of the user may be maintained by a so-called IBAN system executing at a server computer system. The profile may be updated dynamically based on the data collected by electronic sensing devices within the IBAN of the user. For example, data collected from a certain electronic sensing device within the IBAN may indicate that the user performs a cardio-intensive activity (e.g., working out at a gym) at certain time of day. Data collected from another electronic sensing device within the IBAN may indicate a current geographic location of a user. The IBAN system may be configured to generate an alert based on the current data from electronic sensing devices within the IBAN and the profile of the user if, e.g., the user's heart rate is indicative of cardio-vascular activity while the user's geographic location is associated with a work place of the user.

The profile of a user may include a variety of information, such as, e.g., information about the user's existing wardrobe. The data can include colors, sizes, shapes and types of wardrobe items. This data may be utilized as the user is shopping on-line. As the user requests a search with respect of certain item of closing, the IBAN system may filter the results using the size information, user's favorite brand information, and other information stored in the user's profile. The IBAN system may also be configured to determine colors that would be desirable based on the user's current wardrobe, and filter search results based on color-coordination rules that may also be maintained by the IBAN system. Other data that can be maintained, aggregated and processed by an IBAN system includes information associated with music taste of the user, reading patterns and interests of the user, hobbies of the user, etc.

In one example embodiment, a profile of a user may include a static profile and a non-static profile. A static profile stores information about the user that remains unchanged unless the user initiates the update process. For example, a static profile may store information, such as the name of the user, the billing address of the user, the date of birth of the user, etc. A non-static profile may be configured to store information that is automatically updated based on the data collected by the electronic sensing devices provided within the IBAN of the user. An example non-static profile may include one or more so-called historical profiles. Each historical profile in a non-static profile of a user may store a particular type of information and may be configured to expire after a predetermined period of time. For example, a historical profile may include information about the user's activities or hobbies. Another historical profile may include correlation between two or more activities or correlation between data collected from different electronic sensing devices within the IBAN of the user during the same period of time (e.g., information reflecting the type of music the user is listening to while the user is running or driving). Each historical profile in the non-static profile of a user may have an expiration date. For example, an expiration date of a historical profile that stores data related to the user's vital signs may be set to expire one hour after the data in this historical profile has been updated.

A system and method may be provided to build and maintain a non-static time-sensitive profile using electronic sensing devices within a user's IBAN. The data collected from the electronic sensing devices within a user's IBAN may be recognized as indicative of certain activities performed by the user (e.g., driving, skiing, exercising or dancing), of the user's location, of current weather conditions and lighting, of the state of the user's body (motion, lack of or existence of a rhythm, as in dancing), etc. This data can be used to build and maintain a non-static profile of the user, which can then be utilized to make context-sensitive recommendations to the user. The context, for the purposes of this description, may be understood as any current information associated with the user, such as, e.g., the activity the user is engaged in, the biometrics of the user, the current geographic location of the user, etc. As data collected by a sensing electronic device is received at an IBAN system, the IBAN system may determine the identification of the sensor from which the received data has been collected, as well as the context associated with the received data (e.g., the context may be associated with the user being in the process of running at a moderate speed). Based on the context, the IBAN system may generate a communication for the user (e.g., a message stating that it may be time to purchase a new pair of running shoes).

As mentioned above, an IBAN system may be provided at a server computer system. An IBAN mobile application (IBAN app) may be provided at a smart phone of a user. An IBAN app may be configured to be in communication with various electronic sensing devices within an IBAN and also communicate with a server computer system that hosts an IBAN system. An IBAN app may be configured to generate communications for a user directly in response to data received from the electronic sensing devices within the associated IBAN. In some embodiments, an IBAN app may also be configured to generate communications for a user based on data collected by the electronic sensing devices within the associated IBAN and additional information provided by an IBAN system hosted at a server computer system. Method and system to build a time-sensitive profile may be implemented in the context of a network environment 100 illustrated in FIG. 1.

As shown in FIG. 1, the network environment 100 may include electronic sensing devices 110, 112, and 114, a smart phone 120, and a server system 140. The electronic sensing devices 110, 112, and 114, as well as the smart phone 120 may be positioned over a person's body, may communicate with each other utilizing Near Field Communication (NFC) or short-wavelength radio transmissions, and may form an intra-body area network (IBAN) 116. The communication channels NFC or short-wavelength radio transmissions within the IBAN 116 are designated by the broken curved lines in FIG. 1. As mentioned above. The electronic sensing devices 110, 112, and 114 may be embedded in or attached to items of clothing, shoes, headgear, earrings, glasses, etc., and may collect variety of data, such as, e.g., biometrics of the user, geographic location of the user, visual and environmental surroundings of the user, etc. The smart phone 120 may include an IBAN mobile application (IBAN app) 122 that may be configured to receive or obtain, and also process, collected data from the electronic sensing devices 110, 112, and 114. The IBAN app 122 may also be configured to generate communications to the user associated with IBAN. Such communications may include messages, images, alerts, vibration alarms, etc. The IBAN app 122 may further be configured to communicate with the server system 140, and, specifically, with an IBAN system 144 provided at the server system 140. It will be noted, that the server system 140 may be embodied in one or several physical computing devices.

The electronic sensing devices 110, 112, and 114, as well as the smart phone 120 may also be in communication with the server system 140 via a communications network 130. The communications network 130 may be a public network (e.g., the Internet, a mobile communication network, or any other network capable of communicating digital data). For example, the IBAN app 122 executing at the smart phone 120 may communicate raw or processed data collected by the electronic sensing devices 110, 112, and 114 to IBAN system 144 executing at the server system 140. The IBAN system 144, in turn, may analyze, aggregate, or otherwise process the data collected by the electronic sensing devices 110, 112, and 114 and generate communications for the user associated with IBAN. In one embodiment, the communication generated by the IBAN system 144 may be provided to the user via the smart phone 120.

The server system 140, in one example embodiment, may host an on-line trading platform 142. The on-line trading platform 142 hosted by the server system 140, in one example embodiment, provides a place for buyers and sellers to come together and trade almost anything. In the context of one example on-line trading platform, a seller lists an item—most anything from antiques to cars, books to sporting goods. The seller chooses to either accept only bids for the item (an auction-type listing) or to offer the so-called “Buy It Now” option, which allows buyers to purchase the item right away at a fixed price. In some embodiments, the IBAN system 144 may be integrated with the on-line trading platform 142.

Also shown in FIG. 1 is database 150 that may be used to store profiles of users as profiles 152. A profile of a user may include a static profile that may store information, such as the name of the user, the billing address of the user, the date of birth of the user, etc., and a non-static profile. While information stored in a static profile may remain unchanged unless the user requests a change, a non-static profile may store information that is automatically updated based on the data collected by the electronic sensing devices provided within the IBAN of the user. As mentioned above, an example non-static profile may include one or more so-called historical profiles, where each historical profile stores a particular type of information and is associated with an expiration date. The IBAN system 144 may be configured to update profiles stored in the database 150, based on data collected by the electronic sensing devices 110, 112, and 114. An example profile 200 of a user is shown in FIG. 2.

As shown in FIG. 2, the profile 200 includes a static profile 210 and a non-static profile 220. Example historical profiles included in a non-static profile 300 are shown in FIG. 3. A historical profile 310 stores correlation between data collected from two different electronic sensing devices that collect data related to a main activity and a secondary activity respectively. For example, the main activity reflected in the historical profile 310 may be exercising in a gym, and the secondary activity reflected in the historical profile 310 may be singing or listening to music. The correlation information may be used in generation of a communication for the user, such as, e.g., a recommendation to listen to a certain music sample. A historical profile 320 is shown as storing data indicative of the activities performed by the user with a certain frequency, e.g., the activities that may be considered the user's hobbies. A historical profile 330 is shown as storing data indicative of the correlation of an activity performed by the user and the time of day, during which the activity is being performed. For example, the historical profile 330 may reflect that the user is usually running in the morning. The associated IBAN system may access and use the data stored in the non-static profile 300, as well as update the information stored in the non-static profile 300. Example modules that may be included in an IBAN system (e.g., in the IBAN system 144 and/or in the IBAN app 122) are illustrated in FIG. 4.

FIG. 4 is a block diagram of an example system 400 to build a time-sensitive profile, in accordance with one example embodiment. As shown in FIG. 4, the system 400 includes a data collector 402, a historical profile detector 404, and a profile generator 406. The data collector 402 may be configured to collect data from electronic sensing devices that may be part of an IBAN of a user, such as the electronic sensing devices 110, 112, and 114 illustrated in FIG. 1. For example, the data collector 402 may receive sensor data collected by any of the electronic sensing devices 110, 112, and 114. As mentioned above, electronic sensing devices 110, 112, and 114 may communicate with each other utilizing Near Field Communication (NFC) or short-wavelength radio transmissions, and be embedded in or attached to items of clothing, shoes, headgear, earrings, glasses, etc., and collect data, such as biometrics of the user, geographic location of the user, visual and environmental surroundings of the user, etc.

The historical profile detector 404 may be configured to determine a particular historical profile associated with the received sensor data. For example, the sensor data collected by the electronic sensing device 110 may be indicative of a current activity of the user (e.g., running) and may be reflected in the historical profile 320 of FIG. 3 as a current hobby of the user. The historical profile detector 404 may also be configured to determine that the associated historical profile needs to be updated using the received sensor data. The profile generator 406 may be configured to update the historical profile using the first sensor data and to update the expiration date of the historical profile. The profile generator 406 may also utilize sensor data collected by more the one electronic sensing device in order to update a historical profile. For example, where a historical profile is indicative of a correlation between two activities performed by a user at the same time (e.g., the historical profile 310 of FIG. 3) the profile generator 406 may be updating such historical profile using data form an one electronic sensing device that can collect data associated with the increased physical activity of the user and also from an electronic sensing device that can detect what music the user is listening to.

Also shown in FIG. 4 is a response module 408. The response module 408 may be configured to generate a communication for the user based on the sensor data received from one or more electronic sensing devices from the user's IBAN. In one example embodiment, the response module 408 first determines context associated with the received sensor data, using a profile of the user. As explained above, the profile of a user may include a historical profile and a static profile, where the static profile of the user stores data about the user that is not subject to automatic updates. Based on the determined context, the response module 408 determines one or more rules associated with the context and generate a communication for the user using the one or more rules. For example, the user's profile may indicate that the context associated with sensor data indicative of a certain pattern of motion is “running” and a rule associated with the “running context” is to alert a user that she may need to hydrate. The response module 408 may be configured to generate a message to the user reminding her to drink water when the received sensor data is indicative of the user running.

Any of the modules of the system 400 may reside on a smart phone associated with the IBAN of the user (e.g., the smart phone 120 of FIG. 1 and/or may be provided as part of an IBAN system executing on a server system (e.g., on the server system 140 of FIG. 1). Example operations performed by the system 400 can be described with reference to FIG. 5.

FIG. 5 is a flow chart of a method 500 to build a time-sensitive profile, according to one example embodiment. The method 500 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 400 shown in FIG. 4.

As shown in FIG. 5, the method 500 commences at operation 510, where the data collector 402 receives data from electronic sensing devices that may be part of an IBAN of a user, such as the electronic sensing devices 110, 112, and 114 illustrated in FIG. 1. At operation 520, the historical profile detector 404 of FIG. 4 determines a particular historical profile associated with the received sensor data and that the historical profile needs to be updated using the received sensor data (operation 530). At operation 540, the profile generator 406 updates the historical profile using the first sensor data and updates the expiration date of the historical profile at operation 550.

For example, a historical profile that stores a list of hobbies or favorite activities of a user may be updated when it is determined that a user has taken up a new hobby or is no longer engaged in an activity with any significant frequency. The operation of updating of the historical profile may comprise determining that a count associated with frequency with which data indicative of an activity is above a predetermined threshold value, determining that an identification of the activity is absent from the historical profile, and adding the identification of the activity to the historical profile. Conversely, the operation of updating of the historical profile may comprise determining that a count associated with frequency with which data indicative of an activity is below a predetermined threshold value, an identification of the activity included in the historical profile and removing the identification of the activity from the historical profile.

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 604. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to build a time-sensitive profile has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A method comprising:
receiving, using at least one processor, first sensor data, the first sensor data collected by an electronic sensing device, the electronic sensing device embedded in an item wearable by a user;
determining a historical profile associated with the first sensor data, the historical profile being from one or more historical profiles of the user, the historical profile having an expiration date;
determining that the historical profile is to be updated using the first sensor data;
updating the historical profile using the first sensor data; and
updating the expiration date of the historical profile.

2. The method of claim 1, wherein the electronic sensing device from a plurality of electronic sensing devices, each from the plurality of electronic sensing devices collecting respective different types of information associated with the user.

3. The method of claim 2, wherein the updating of the historical profile is utilizing the first sensor data and a second sensor data, the second sensor data collected by a further electronic sensing device from the one or more electronic sensing devices.

4. The method of claim 1, comprising:
determining, using a profile of the user, context associated with the first sensor data, the profile of the user comprising the historical profile and a static profile of the user, the static profile of the user storing data about the user that is not subject to automatic updates;
determining one or more rules associated with the context; and
using the one or more rules to generate a communication for the user.

5. The method of claim 1, wherein the receiving of the first sensor data is at a smart phone of the user.

6. The method of claim 1, wherein the updating of the historical profile is at a server computing device.

7. The method of claim 1, wherein the historical profile from the one or more historical profiles of the user stores data indicative of a correlation between data collected by the first electronic sensing device and data collected by a second electronic sensing device from the one or more electronic sensing devices.

8. The method of claim 1, wherein the historical profile from the one or more historical profiles of the user stores data indicative of one or more activities of the user.

9. The method of claim 8, wherein the updating of the historical profile comprises:
determining that a count associated with frequency with which data indicative of an activity is above a predetermined threshold value;
determining that an identification of the activity is absent from the historical profile; and
adding the identification of the activity to the historical profile.

10. The method of claim 8, wherein the updating of the historical profile comprises:
determining that a count associated with frequency with which data indicative of an activity is below a predetermined threshold value, an identification of the activity included in the historical profile; and
removing the identification of the activity from the historical profile.

11. A system comprising:
a plurality of electronic sensing devices, each from the plurality of electronic sensing devices being embedded in an item wearable by the user, the plurality of sensing devices collecting respective different types of information, devices from the plurality of electronic sensing devices being in communication with each other;
one or more processors coupled to a memory;
a data collector to receive, using the one or more processors, first sensor data, the first sensor data collected by an electronic sensing device, the electronic sensing device embedded in an item wearable by a user;
a historical profile detector to, using the one or more processors:
determine a historical profile associated with the first sensor data, the historical profile being from one or more historical profiles of the user, the historical profile having an expiration date, and
determine that the historical profile is to be updated using the first sensor data; and
a profile generator to, using the one or more processors:
update the historical profile using the first sensor data, and
update the expiration date of the historical profile.

12. The system of claim 11, wherein the electronic sensing device from a plurality of electronic sensing devices, each from the plurality of electronic sensing devices collecting respective different types of information associated with the user.

13. The system of claim 12, wherein the profile generator is to update the historical profile utilizing the first sensor data and a second sensor data, the second sensor data collected by a further electronic sensing device from the one or more electronic sensing devices.

14. The system of claim 11, comprising a response module to:
determine, using a profile of the user, context associated with the first sensor data, the profile of the user comprising the historical profile and a static profile of the user, the static profile of the user storing data about the user that is not subject to automatic updates;
determine one or more rules associated with the context; and
generate a communication for the user using the one or more rules.

15. The system of claim 11, wherein the data collector is provided at a smart phone of the user.

16. The system of claim 11, wherein the profile generator is provided at a server computing device.

17. The system of claim 11, wherein the historical profile from the one or more historical profiles of the user stores data indicative of a correlation between data collected by the first electronic sensing device and data collected by a second electronic sensing device from the one or more electronic sensing devices.

18. The system of claim 11, wherein the historical profile from the one or more historical profiles of the user stores data indicative of one or more activities of the user.

19. The system of claim 18, wherein the profile generator is to:
determine that a count associated with frequency with which data indicative of an activity is above a predetermined threshold value;
determine that an identification of the activity is absent from the historical profile; and
add the identification of the activity to the historical profile.

20. A machine-readable non-transitory storage medium having instruction data to cause a machine to:
receive first sensor data, the first sensor data collected by an electronic sensing device, the electronic sensing device embedded in an item wearable by a user;
determine a historical profile associated with the first sensor data, the historical profile being from one or more historical profiles of the user, the historical profile having an expiration date;
determine that the historical profile is to be updated using the first sensor data;
update the historical profile using the first sensor data; and
update the expiration date of the historical profile.
